(19) United States
(12) Patent Application Publication
(10) Pub. No.: US 2026/0093617 A1
(43) Pub. Date: Apr. 2, 2026

(54) NON-VOLATILE MEMORY DEVICE USING SEPARATE COMMAND/ADDRESS INTERFACE AND STORAGE DEVICE AND OPERATION METHOD THEREOF

(71) Applicant: Samsung Electronics Co., Ltd., Suwon-si (KR)

(72) Inventor: Yong-Taek JEONG, Suwon-si (KR)

(73) Assignee: Samsung Electronics Co., Ltd., Suwon-si (KR)

(21) Appl. No.: 19/053,882

(22) Filed: Feb. 14, 2025

(30) Foreign Application Priority Data
Sep. 27, 2024 (KR) 10-2024-0131275

(51) Int. Cl. G06F 12/02

(52) U.S. Cl. CPC G06F 12/0223

(57) ABSTRACT

Disclosed is a storage device comprising a storage controller configured to transmit a command and an address via a command/address line, the command/address line separate from a data line, and a non-volatile memory device configured to exchange a first data with the storage controller via the data line and exchange a second data in synchronization with the first data via the command/address line. The storage controller transmits a sub-address associated with selecting at least one of a plurality of sub-data in synchronization with the first data to the non-volatile memory device using the command/address lines.

### CROSS-REFERENCE TO RELATED APPLICATIONS

This application claims priority under 35 U.S.C. § 119 to Korean Patent Application No. 10-2024-0131275 filed on Sep. 27, 2024, in the Korean Intellectual Property Office, the disclosures of which are incorporated by reference herein in their entireties.

### BACKGROUND

Example embodiments of the present disclosure described herein relate to a semiconductor memory device, and more particularly, to a non-volatile memory device using a separate command/address interface, a storage device, and an operating method thereof.

Semiconductor memory devices can be broadly divided into volatile memory and non-volatile memory. Volatile memory (e.g., DRAM or SRAM) has fast read/write speeds, but stored data disappears when power is cut off. On the other hand, non-volatile memory can maintain stored data even when power is cut off. A representative example of non-volatile memory is flash memory.

Meanwhile, as technology advances, the desire for improved data input/output speeds of flash memory devices is increasing. In particular, it may be difficult to meet this demand for high speed with the existing interfacing method of inputting commands, addresses, and data through input/output I/O pins. Therefore, attempts to separate command/address CA pins and data DQ pins are also being applied to non-volatile memory devices. Therefore, techniques for more efficient memory operations using a separate command/address SCA interface may be desired.

### SUMMARY

Some example embodiments of the present disclosure provide a non-volatile memory device capable of transmitting various data using a separate command/address SCA type interface.

According to some example embodiments of the inventive concepts, a storage device comprises a storage controller configured to transmit a command and an address via a command/address line, the command/address line separate from a data line, and a non-volatile memory device configured to exchange a first data with the storage controller via the data line and exchange a second data in synchronization with the first data via the command/address line. The storage controller transmits a sub-address associated with selecting at least one of a plurality of sub-data in synchronization with the first data to the non-volatile memory device using the command/address lines.

According to some example embodiments of the inventive concepts a non-volatile memory device comprises a cell array including a memory area is configured to be selected by a first address, a page buffer configured to sense a read data from the selected memory area, a sub-data register configured to store a plurality of sub-data corresponding to the read data, a control circuit configured to provide a second address associated with selecting at least one of the plurality of sub-data to the sub-data register, and an input/output circuit configured to receive the first address and the second address through a command/address line, the command/address line separate from a data line, provide the first address and the second address to the control circuit, and output a selected sub-data of the plurality of sub-data to the command/address line in synchronization with the output of the read data.

According to some example embodiments of the inventive concepts, a method of operating a non-volatile memory device comprises receiving a command, a first address, and a second address through a command/address line, the command/address line separate from a data line, sensing a read data corresponding to the first address, selecting at least one of a plurality of sub-data according to the second address, outputting the read data through the data line, and outputting the at least one of a plurality of sub-data selected in synchronization with the output of the read data through the command/address line.

### BRIEF DESCRIPTION

The above and other objects and features of the present disclosure will become apparent by describing in detail some example embodiments thereof with reference to the accompanying drawings.

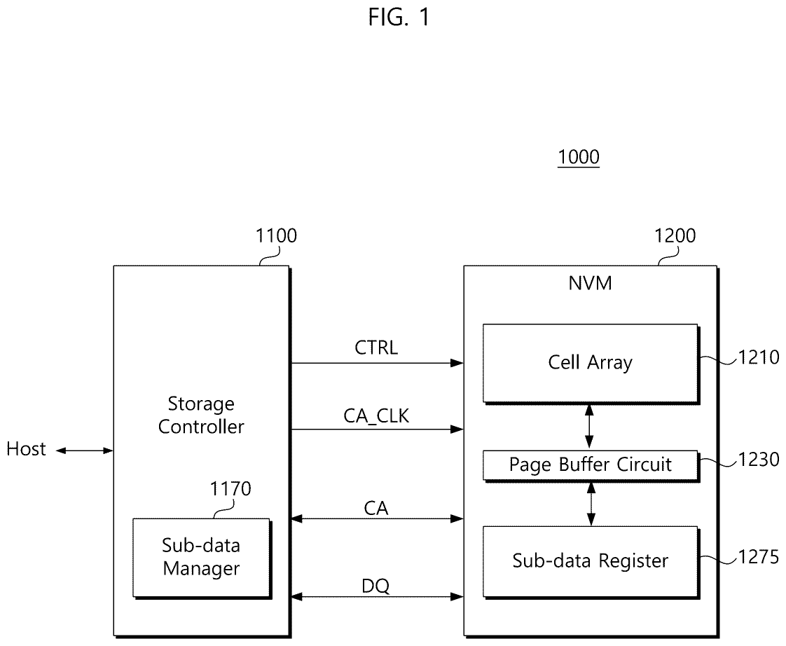

FIG. 1 is a block diagram showing a storage device according to some example embodiments of the present invention.

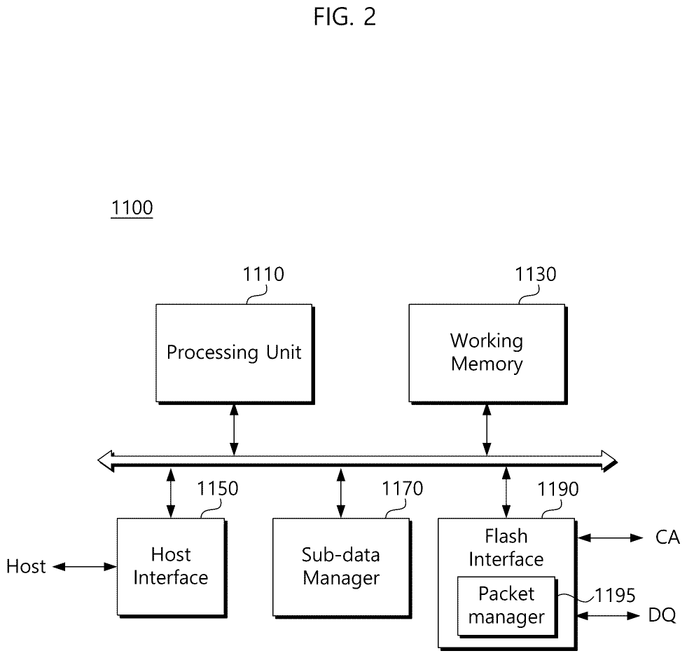

FIG. 2 is a block diagram showing the configuration of the storage controller of FIG. 1 in more detail.

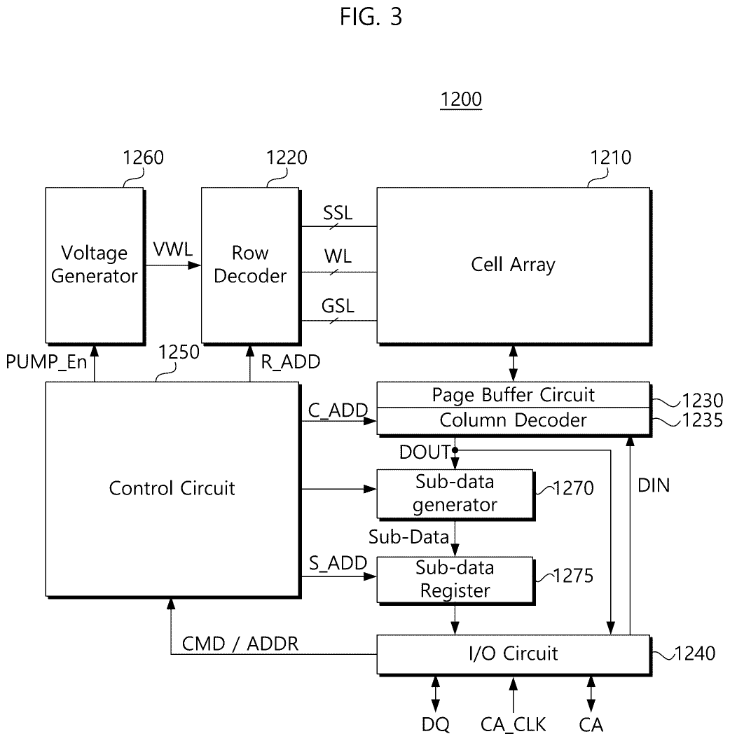

FIG. 3 is a block diagram showing the structure of the non-volatile memory device of FIG. 1 in more detail.

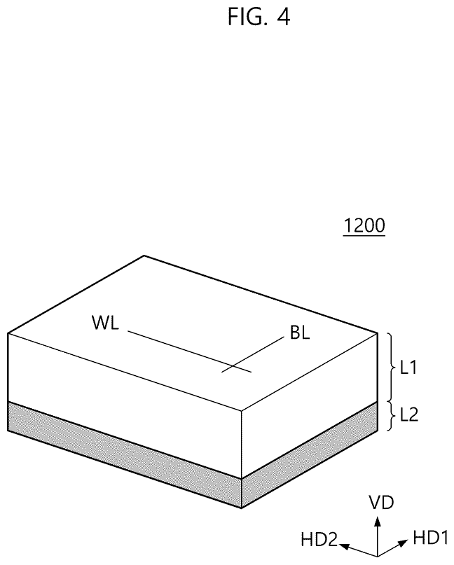

FIG. 4 is a block diagram schematically showing the structure of the non-volatile memory device according to some example embodiments of the present invention.

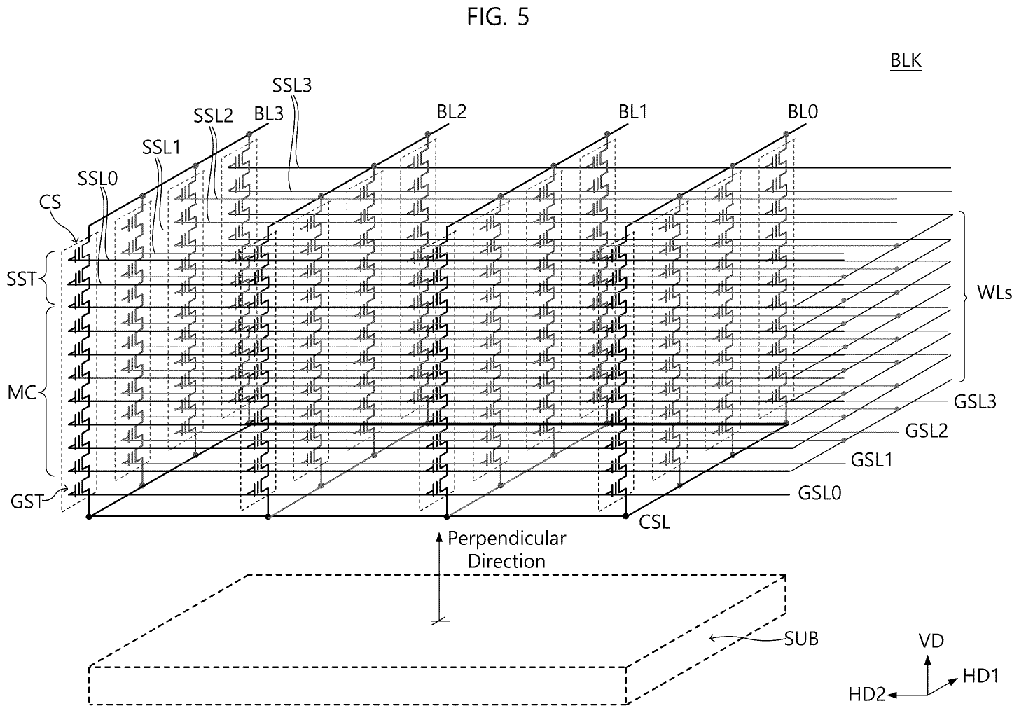

FIG. 5 is a circuit diagram showing an example structure of a memory block constituting the cell array of FIG. 3.

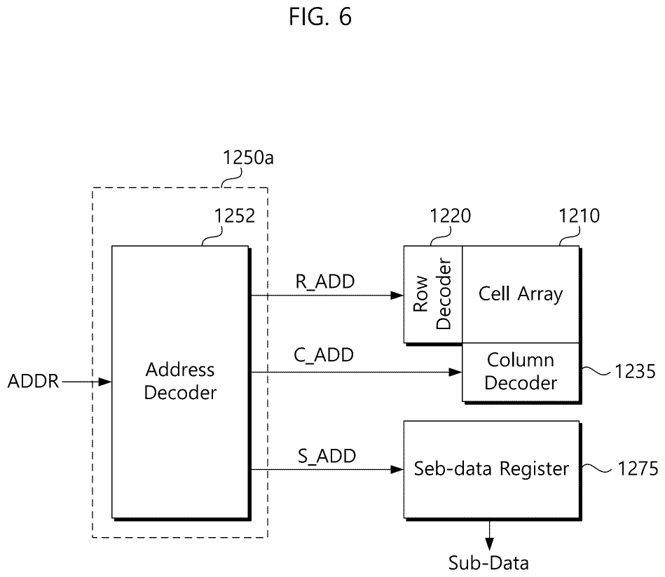

FIG. 6 is a block diagram showing some example embodiments of an address decoder included in the control circuit of FIG. 3.

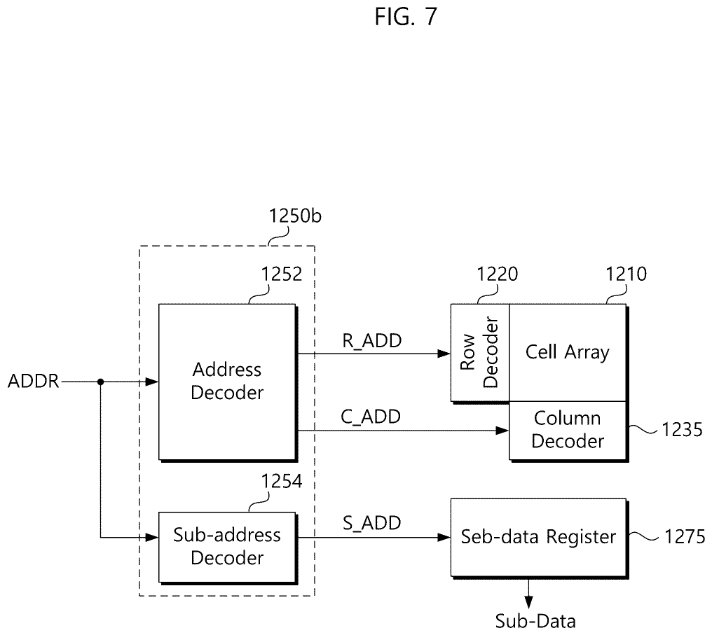

FIG. 7 is a block diagram showing some example embodiments of an address decoder included in the control circuit of FIG. 3.

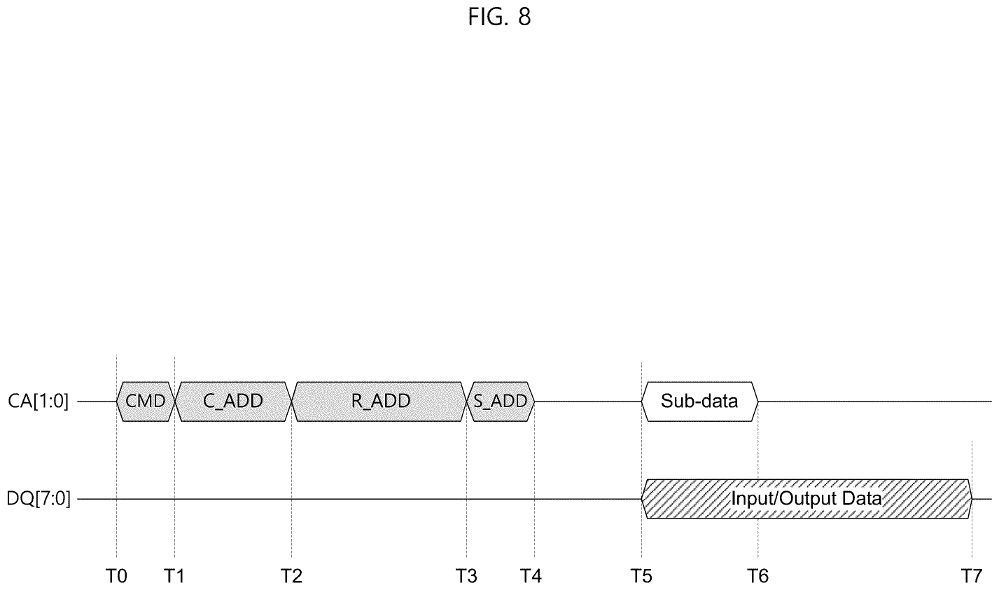

FIG. 8 is a timing diagram showing a method of exchanging data with a non-volatile memory device using the separate command/address SCA protocol of some example embodiments.

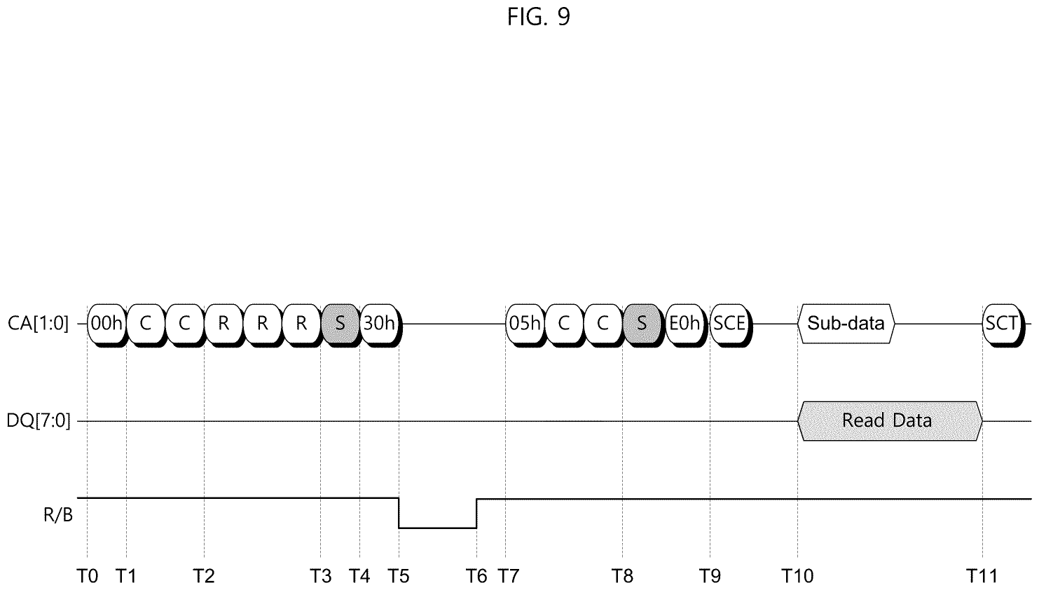

FIG. 9 is a timing diagram showing a read operation of a storage device using the separate command/address SCA protocol of some example embodiments.

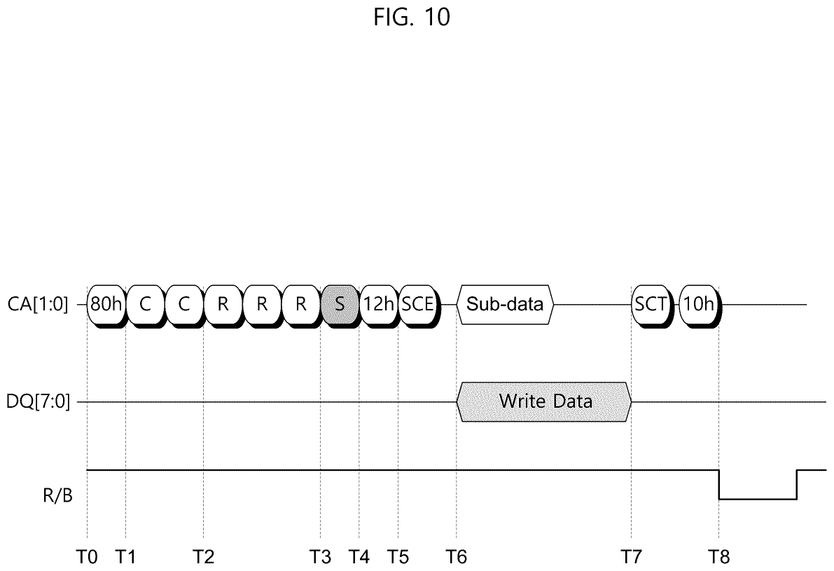

FIG. 10 is a timing diagram showing a write operation of a storage device using the separate command/address SCA protocol of some example embodiments.

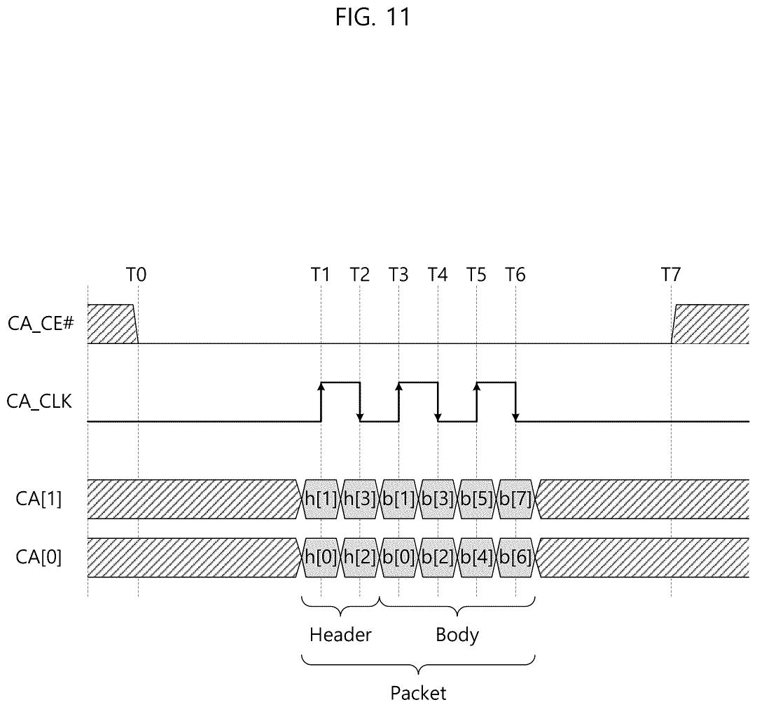

FIG. 11 is a timing diagram showing an example of a packet configuration applied to the separate command/address SCA protocol of some example embodiments.

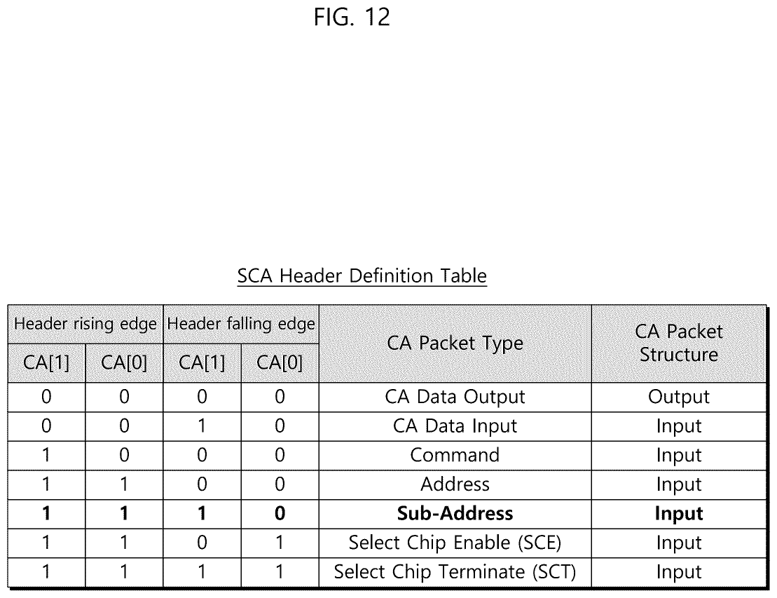

FIG. 12 is a table showing the definition of packet data according to the bit value of the packet header of FIG. 11.

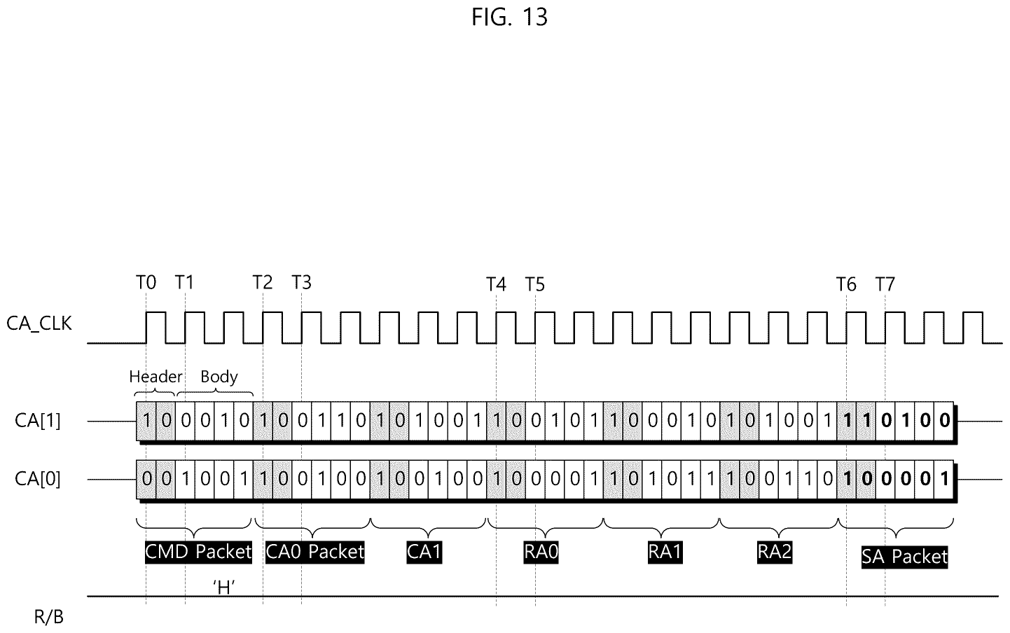

FIG. 13 is a timing diagram showing a command and address transmission method using the separate command/address SCA protocol of some example embodiments.

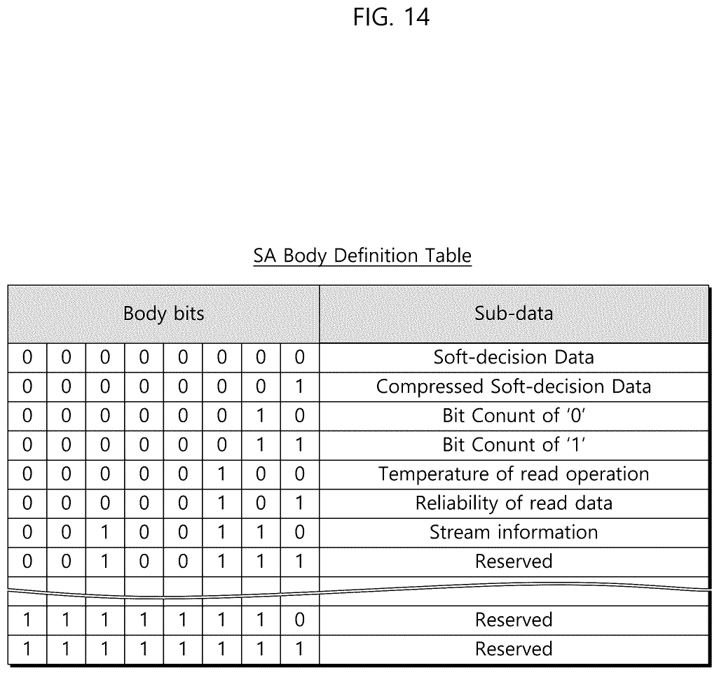

FIG. 14 is a table showing sub-data selected by the body bit of the sub-address packet shown in FIG. 13 as an example.

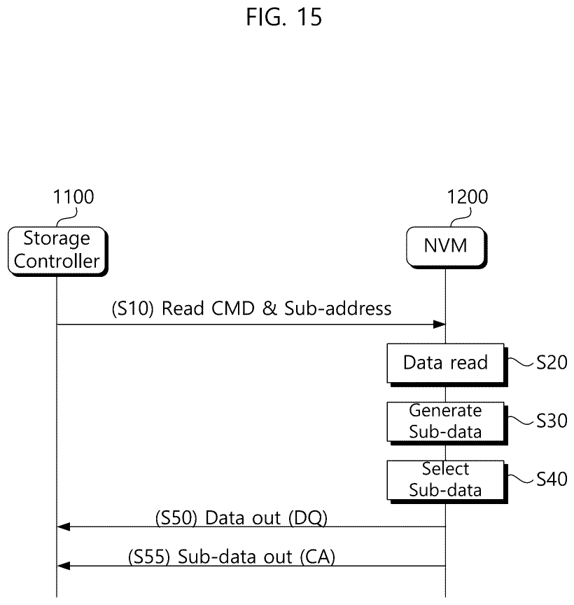

FIG. 15 is a diagram showing a process of outputting sub-data in a storage device using the separate command/address SCA protocol.

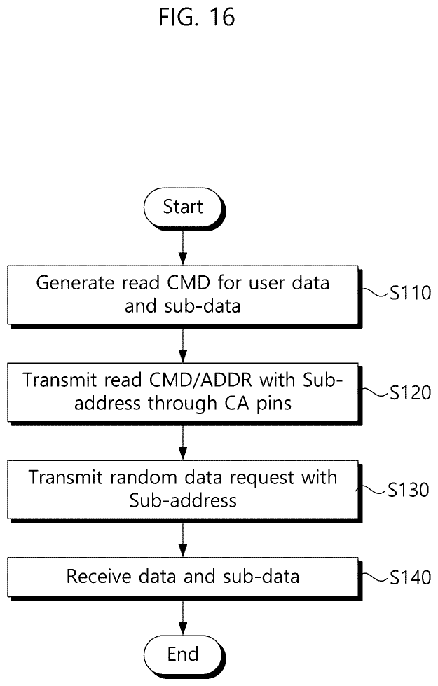

FIG. 16 is a flowchart showing an operation method according to the separate command/address SCA protocol of the storage controller of some example embodiments.

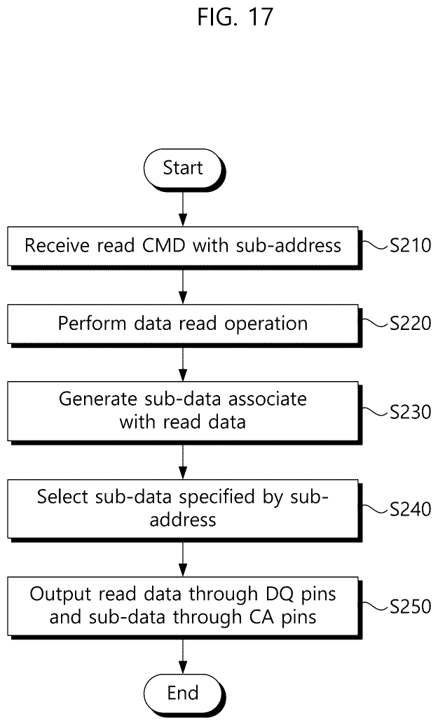

FIG. 17 is a flowchart showing an operation method according to the separate command/address SCA protocol of the non-volatile memory device of some example embodiments.

### DETAILED DESCRIPTION

It is to be understood that both the foregoing general description and the following detailed description are example embodiments, and additional descriptions of the claimed invention is provided. Reference signs are indicated in detail in some example embodiments of the present invention, examples of which are indicated in the reference drawings. Wherever possible, the same reference numbers are used in the description and drawings to refer to the same or like parts.

FIG. 1 is a block diagram showing a storage device according to some example embodiments of the present invention. Referring to FIG. 1, a storage device 1000 may include a storage controller 1100 and a non-volatile memory device 1200. The storage controller 1100 may exchange data with the non-volatile memory device 1200 according to a separate command/address SCA protocol. For example, each of the storage controller 1100 and the non-volatile memory device 1200 may be provided as one chip, one package, or one module. Alternatively, the storage controller 1100 and the non-volatile memory device 1200 may be configured as one chip, one package, or one module. The storage controller 1100 and the non-volatile memory device 1200 can configure storage devices such as embedded memory, memory cards, memory sticks, and solid state drive SSD.

The storage controller 1100 writes data to the non-volatile memory device 1200 or reads data stored in the non-volatile memory device 1200 according to a request from the host. Data requested to be written by the host can be stored in the non-volatile memory device 1200 under the control of the storage controller 1100. The storage controller 1100 generates a command CMD, an address ADDR, a CA clock signal CA_CLK, and a control signal CTRL for accessing the non-volatile memory device 1200.

The storage controller 1100 and the non-volatile memory device 1200 apply a separate command/address SCA protocol for data exchange. That is, the storage controller 1100 and the non-volatile memory device 1200 use a command/address line CA separate from the data line DQ to transmit commands and addresses. The storage controller 1100 and the non-volatile memory device 1200 exchange write data or read data through the data line DQ. The storage controller 1100 or the non-volatile memory device 1200 can exchange sub-data (or sub-data) indicating properties, reliability, importance, etc. of the write data or read data through the command/address line CA. That is, the storage controller 1100 and the non-volatile memory device 1200 can exchange sub-data (or sub-data) such as information for error correction of the corresponding data (soft decision data and compressed soft decision data) or access environment and stream information when transmitting the write data or read data.

In particular, the storage controller 1100 can provide a sub-address (hereinafter, S_ADD) for selecting sub-data requested during a read operation or a write operation. For example, a sub-address S_ADD may be used for selecting one of a plurality of sub-data stored in a sub-data register 1275. The storage controller 1100 can add the sub-address S_ADD together with the row address R_ADD and the column address C_ADD provided together with a read command or a write command.

During a data write operation, the storage controller 1100 can transmit a write command and an address and a sub-address S_ADD to a non-volatile memory device 1200 through the command/address line CA. In addition, the storage controller 1100 transmits write data to the non-volatile memory device 1200 through the data line DQ. At this time, the sub-data specified by the sub-address S_ADD may be transmitted to the non-volatile memory device 1200 through the command/address line CA in synchronization with the write data.

During the data read operation, the storage controller 1100 can transmit the read command, address, and sub-address S_ADD to the non-volatile memory device 1200 through the command/address line CA. The non-volatile memory device 1200 senses the read data according to the read command and the sub-address S_ADD. In addition, the non-volatile memory device 1200 generates various sub-data corresponding to the read data and stores them in the sub-data register 1275. Thereafter, the non-volatile memory device 1200 outputs the read data to the storage controller 1100 through the data line DQ. The non-volatile memory device 1200 selects sub-data from the sub-data register 1275 according to the sub-address S_ADD. The selected sub-data may be transmitted to the storage controller 1100 through the command/address line CA in synchronization with the read data.

The storage controller 1100 may include a sub-data manager 1170 for generating and managing sub-data transmitted in synchronization with the write data and decoding sub-data received in synchronization with the read data. The sub-data manager 1170 generates sub-data corresponding to the write data during the write operation. The sub-data manager 1170 may receive and decode sub-data output in synchronization with the read data during the read operation.

In order to apply the separate command/address SCA protocol, the storage controller 1100 uses a CA clock signal CA_CLK for driving the command/address line CA. A command, address, or data transmitted to the command/address line CA in synchronization with the CA clock signal CA_CLK can be transmitted to the non-volatile memory device 1200.

The non-volatile memory device 1200 exchanges data with the storage controller 1100 according to the separate command/address SCA protocol. The non-volatile memory device 1200 can receive the command and the address (row address, column address, sub-address) from the storage controller 1100 through the command/address line CA. During the write operation, the non-volatile memory device 1200 can receive a write command, addresses (row address, column address, sub-address), and sub-data through the command/address line CA, and write data through the data line DQ. In the read operation, the non-volatile memory device 1200 can receive a read command and addresses (row address, column address, sub-address) through the command/address line CA. In response to the read command, the page buffer circuit 1230 senses a target area of the cell array 1210 and stores sensed data as read data. Various sub-data related to the read data are stored in the sub-data register 1275. The sub-address S_ADD is provided to select one of the various sub-data stored in the sub-data register 1275. The sub-data may include information for error correction (soft decision data and compressed soft decision data), reliability data, sensing environment, stream information, etc.

The non-volatile memory device 1200 may include the cell array 1210, the page buffer circuit 1230, and the sub-data register 1275. The cell array 1210 may include a plurality of memory blocks. Each of the plurality of memory blocks may have a vertical three-dimensional structure. Each memory block may be composed of a plurality of memory cells. The cell array 1210 may be located on the side or above the page buffer circuit 1230.

The page buffer circuit 1230 may include analog circuits or digital circuits configured to store data in the cell array 1210 or read data stored in the cell array 1210. The page buffer circuit 1230 may program write-requested data into the target area of the cell array 1210. In addition, the page buffer circuit 1230 may sense read-requested data from the target area of the cell array 1210.

The sub-data register 1275 stores various sub-data related to the read data sensed by the page buffer circuit 1230. The sub-data register 1275 can output one sub-data in response to the sub-address S_ADD provided through the command/address line CA. In some example embodiments, it will be well understood that the sub-data register 1275 can also be implemented as a non-volatile memory.

According to the storage device 1000 of the example embodiments described above, sub-data between the storage controller 1100 and the non-volatile memory device 1200 can be transmitted at high speed according to the separate command/address SCA protocol. At this time, the sub-address for selecting the sub-data can be provided through the command/address line CA together with the row address and column address. It is expected that the types of sub-data for improving data reliability may rapidly increase in the future as memory technology develops. Some example embodiments of the present invention can provide an address protocol that can select at least one of various sub-data.

FIG. 2 is a block diagram showing the configuration of the storage controller of FIG. 1 in more detail. Referring to FIG. 2, the storage controller 1100 of some example embodiments of the present invention includes a processing unit 1110, a working memory 1130, a host interface 1150, a sub-data manager 1170, and a flash interface 1190. However, it will be well understood that the components of the storage controller 1100 are not limited to the components illustrated. For example, the storage controller 1100 may further include a read only memory ROM that stores code data utilized for a booting operation or an error correction code ECC block.

The processing unit 1110 may include a central processing unit or a microprocessor. The processing unit 1110 may drive firmware that is executed in the storage controller 1100. In particular, the processing unit 1110 can drive various firmware or software loaded into the working memory 1130. In addition, the processing unit 1110 can execute firmware or software that is in charge of core functions of the storage device 1000, such as the host interface layer HIL or the flash translation layer FTL.

Software (or firmware) or data for controlling the storage controller 1100 is loaded into the working memory 1130. The software and data loaded into the working memory 1130 are driven or processed by the processing unit 1110. The flash translation layer FTL driven by the processing unit 1110 generally performs functions such as address mapping, garbage collection, and wear leveling.

The host interface 1150 provides an interface between the host and the storage controller 1100. The host and the storage controller 1100 can be connected via one of various standardized interfaces. Here, the standardized interfaces include various interface methods such as advanced technology attachment ATA, serial ATA (SATA), external SATA (e-SATA), small computer small interface SCSI, serial attached SCSI (SAS), peripheral component interconnection PCI, PCI Express PCIe, universal serial bus USB, IEEE 1394, universal flash storage UFS, embedded multimedia card eMMC, NVMe, etc. However, example embodiments are not limited thereto.

The sub-data manager 1170 can perform decoding on sub-data transmitted from the non-volatile memory device 1200. For example, if the sub-data is compressed soft-decision data, the sub-data manager 1170 can perform decompressing. Afterwards, if a failure occurs in error correction decoding for the hard decision data, error correction can be performed through decoding using the decompressed soft decision data. In other example embodiments, the sub-data manager 1170 may be included in the error correction block.

The flash interface 1190 provides an interface between the storage controller 1100 and the non-volatile memory device 1200. For example, data processed by the processing unit 1110 is stored in the non-volatile memory device 1200 through the flash interface 1190. As another example, data stored in the non-volatile memory device 1200 can be outputted to the storage controller 1100 through the flash interface 1190. In particular, the flash interface 1190 communicates with the non-volatile memory device 1200 using the separate command/address SCA protocol of some example embodiments of the present invention. That is, the flash interface 1190 can communicate with the non-volatile memory device 1200 through a command/address line CA that operates separately from the data line DQ.

In order to apply the separate command/address SCA protocol, the flash interface 1190 can include a packet manager 1195. The packet manager 1195 can generate a packet according to the separate command/address SCA protocol for communication with the non-volatile memory device 1200. For example, the packet manager 1195 can generate a command packet or an address packet for transmitting the write command or the read command to the command/address line CA. Alternatively, the packet manager 1195 can parse a packet received from the command/address line CA and the data line DQ in response to a read command. The flash interface 1190 can transmit commands, addresses (column addresses, row addresses, sub-addresses), sub-data, etc. to the non-volatile memory device 1200 through the command/address line CA.

According to the storage controller 1100 of some example embodiments of the present invention described above, the storage controller 1100 can receive sub-data from the non-volatile memory device 1200 by applying the separate command/address SCA protocol. In particular, the storage controller 1100 can transmit the sub-address S_ADD that can select the type of sub-data to the non-volatile memory device 1200 through the command/address line CA. The types of sub-data for improving data reliability may rapidly increase in the future according to the demand for high integration and high performance. According to some example embodiments of the present invention, an interface that can select at least one of many sub-data can be provided.

FIG. 3 is a block diagram showing the structure of the non-volatile memory device of FIG. 1 in more detail. Referring to FIG. 3, the non-volatile memory device 1200 may include a cell array 1210, a row decoder 1220, a page buffer circuit 1230, a column decoder 1235, an input/output circuit 1240, a control circuit 1250, a voltage generator 1260, a sub-data generator 1270, and a sub-data register 1275.

The cell array 1210 may include a plurality of memory blocks. Each of the plurality of memory blocks may have a vertical three-dimensional structure. Each of the memory blocks may be composed of a plurality of pages. Each page may be composed of a plurality of memory cells. Each memory block may be an erase unit, and each page may be a read or write unit. The cell array 1210 may be formed in a vertical direction with respect to the substrate. On the substrate, a gate electrode layer and an insulation layer may be alternately deposited. Each memory block may be connected to a string selection line SSL, a plurality of word lines, and a ground selection line GSL. The number of stacked gate electrode layers on which word lines of the cell array 1210 are formed is increasing as the product generation develops.

The row decoder 1220 may select a word line of the cell array 1210 in response to a row address R_ADD. The row decoder 1220 provides a word line voltage VWL provided from a voltage generator 1260 to the cell array 1210 through the selection lines SSL and GSL and the word line WL. The row decoder 1220 may select the word line during a program or read operation. The row decoder 1220 can provide a program voltage or a read voltage to the selected word line.

The page buffer circuit 1230 can be connected to the cell array 1210 through a bit line. The page buffer circuit 1230 can pre-charge or sense the bit lines connected to the memory cell in response to a control signal provided from the control circuit 1250. The page buffer circuit 1230 can operate as a write driver or a sense amplifier depending on the operation mode. During a program operation, the page buffer circuit 1230 can apply a bit line voltage corresponding to data to be programmed to the selected bit line. During a read operation, the page buffer circuit 1230 can detect the data stored in the memory cell by detecting the current or voltage of the selected bit line.

The column decoder 1235 can select a bit line of the cell array 1210 in response to a column address C_ADD. The column decoder 1235 provides data DIN input for the program to the page buffer circuit 1230 of the selected column. The column decoder 1235 can provide data DOUT output from the page buffer circuit 1230 to the input/output circuit 1240 or the sub-data generator 1270 in units of the selected column.

The input/output circuit 1240 receives write data, commands, addresses, and control signals provided from the storage controller 1100. The commands and addresses received from the input/output circuit 1240 can be provided to the control circuit 1250. The input/output circuit 1240 receives write data, command CMD, and address ADDR according to the separate command/address SCA protocol. That is, the input/output circuit 1240 parses the packet-type command CMD and address ADDR provided through the command/address line CA and transmits them to the control circuit 1250. The input/output circuit 1240 can transmit the write data transmitted through the data line DQ to the page buffer circuit 1230. The input/output circuit 1240 can encode the selected sub-data output from the sub-data register 1275 in the form of a packet and output it to the outside through the command/address line CA. In other example embodiments, the input/output circuit 1240 can also output the sub-data to the outside through the data line DQ. The input/output circuit 1240 can receive the command, address, or sub-data transmitted through the command/address line CA in synchronization with the CA clock signal CA_CLK.

The control circuit 1250 can control various operations within the non-volatile memory device 1200 according to an operation mode. The control circuit 1250 can perform program, read, erase operations in response to a command CMD and/or an address ADDR. For example, the control circuit 1250 can generate a pump enable signal PUMP_En for a program operation. The control circuit 1250 can control the voltage generator 1260 to generate a voltage utilized for read, write, and erase operations by providing the pump enable signal PUMP_En. The control circuit 1250 decodes the address ADDR provided through the command/address line CA and transmits it to the row decoder 1220, the column decoder 1235, and the sub-data register 1275.

The voltage generator 1260 can generate a word line voltage VWL utilized to read or write data in response to a pump enable signal PUMP_En from the control circuit 1250. The word line voltage VWL can be provided to a selected word line or an unselected word line through the row decoder 1220. The voltage generator 1260 can include a charge pump (not shown) for this purpose. The voltage generator 1260 can generate a word line voltage provided during a program operation or a word line voltage provided during a read operation.

The sub-data generator 1270 can generate sub-data from data DOUT output from the page buffer circuit 1230 under the control of the control circuit 1250. The sub-data can be soft-decision data for the output data DOUT or compressed soft-decision data. The sub-data may be a count value of the number of bits of logic ‘1’ or logic ‘0’ included in the output data DOUT. Alternatively, the sub-data generator 1270 may generate operating temperature information at the time when the data is sensed in the page buffer circuit 1230. At this time, the operating temperature information may be provided from a temperature sensor (not shown) mounted inside the non-volatile memory device 1200. The sub-data may correspond to various reliability data, setting data, or metadata for the output data DOUT from the page buffer circuit 1230.

The sub-data register 1275 stores various sub-data generated by the sub-data generator 1270. The sub-data register 1275 transmits at least one sub-data selected in response to the sub-address S_ADD to the input/output circuit 1240.

In the case where sub-data is not used, output data DOUT from the page buffer circuit 1230 may be directly transmitted to the input/output circuit 1240 without passing through the sub-data generator 1270 or the sub-data register 1275.

According to the non-volatile memory device 1200 of some example embodiments of the present invention, the command, the address, and sub-data can be received from the storage controller 1100 according to the separate command/address SCA protocol. In addition, the non-volatile memory device 1200 can output sub-data selected through the sub-address S_ADD through the command/address line CA. Therefore, the non-volatile memory device 1200 can increase the utilization of the command/address line CA through the transmission of sub-data. In addition, the non-volatile memory device 1200 can provide sub-data to the storage controller 1100 at higher speed.

FIG. 4 is a block diagram schematically showing the structure of a non-volatile memory device according to some example embodiments of the present invention. Referring to FIG. 4, the non-volatile memory device 1200 may include a first semiconductor layer L1 and a second semiconductor layer L2, and the first semiconductor layer L1 may be stacked in a vertical direction VD relative to the second semiconductor layer L2. Specifically, the second semiconductor layer L2 may be arranged below the first semiconductor layer L1 in a vertical direction VD, and thus, the second semiconductor layer L2 may be arranged close to the substrate.

In some example embodiments, the cell array 1210 of FIG. 3 may be formed on the first semiconductor layer L1, and peripheral circuits corresponding to the row decoder 1220, page buffer circuit 1230, control circuit 1250, and voltage generator 1260 of FIG. 3 may be formed on the second semiconductor layer L2. Accordingly, the non-volatile memory device 1200 may have a structure in which the cell array 1210 is arranged on top of the peripheral circuit, e.g., a cell over periphery COP structure. The COP structure may effectively reduce the horizontal area and/or may improve the integration of the non-volatile memory device 1200.

In some example embodiments, the second semiconductor layer L2 may include a substrate, and a peripheral circuit may be formed on the second semiconductor layer L2 by forming transistors and metal patterns for wiring the transistors on the substrate. After the peripheral circuit is formed on the second semiconductor layer L2, a first semiconductor layer L1 including a cell array 1210 may be formed, and metal patterns may be formed to electrically connect the word lines WL and bit lines BL of the cell array 1210 and the peripheral circuit formed on the second semiconductor layer L2. For example, the bit lines BL may extend in the first horizontal direction HD1, and the word lines WL may extend in the second horizontal direction HD2.

FIG. 5 is a circuit diagram showing an example structure of a memory block constituting the cell array of FIG. 3. Referring to FIG. 5, cell strings CS are formed between bit lines BL0, BL1, BL2 and BL3 and a common source line CSL to configure a memory block BLK.

A plurality of cell strings are formed between a bit line BL0 and a common source line CSL. A string selection transistor SST of the cell strings CS is connected to a corresponding bit line BL. A ground selection transistor GST of the cell strings CS is connected to a common source line CSL. Memory cells MCs are provided between the string selection transistor SST and the ground selection transistor GST of the cell strings CS.

Each of the cell strings CS includes a ground selection transistor GST. The ground selection transistors GST included in the cell strings CS can be controlled by a ground selection line GSL. Alternatively, although not shown, the cell strings corresponding to each row can be controlled by different ground selection lines.

The circuit structure of memory cells included in one memory block BLK has been briefly described above. However, the circuit structure of the illustrated memory block is a simplified structure for convenience of explanation, and the actual memory block is not limited to the illustrated example. That is, it will be well understood that one physical block may include more semiconductor layers, bit lines BLs, and string selection lines SSLs.

FIG. 6 is a block diagram showing an example of an address decoder included in the control circuit of FIG. 3. Referring to FIG. 6, the address decoder 1252 that may be included in the control circuit 1250a may decode an address ADDR provided through a command/address line CA to output a row address R_ADD, a column address C_ADD, and a sub-address S_ADD.

The address decoder 1252 decodes the address ADDR packet input to a command/address line CA and separates the address ADDR packet into a row address R_ADD, a column address C_ADD, and a sub-address S_ADD. For example, in an address input sequence input after a command CMD, a column address C_ADD can be extracted from two address packets, and a row address R_ADD can be extracted from three address packets. In addition, the sub-address S_ADD can be extracted from one or more subsequent packets. The address decoder 1252 transmits the row address R_ADD extracted from the address packet to the row decoder 1220. The address decoder 1252 transmits the column address C_ADD extracted from the address packet to the column decoder 1235. And the address decoder 1252 can transmit the sub-address S_ADD extracted from the address packet to the sub-data register 1275.

The memory area of the cell array 1210 is selected by the row address R_ADD and the column address C_ADD. During a read operation, user data may be sensed from the memory area of the cell array 1210. At least one of the plurality of sub-data existing in the sub-data register 1275 can be selected and output by the sub-address S_ADD.

FIG. 7 is a block diagram showing some example embodiments of an address decoder included in the control circuit of FIG. 3. Referring to FIG. 7, an address decoder 1252 included in a control circuit 1250b decodes an address ADDR provided through a command/address line CA to generate a row address R_ADD and a column address C_ADD. In addition, a sub-address decoder 1254 decodes the address ADDR to generate a sub-address S_ADD.

The address decoder 1252 can extract the row address R_ADD and the column address C_ADD by decoding an address ADDR packet input through a command/address line CA. For example, among the address ADDR input sequences input after the command CMD, the column address C_ADD can be extracted from two address packets and the row address R_ADD can be extracted from three address packets. However, the address decoder 1252 does not perform processing on a packet corresponding to a sub-address among the address packets. The address decoder 1252 transmits the extracted row address R_ADD to the row decoder 1220 and the column address C_ADD to the column decoder 1235. The memory area of the cell array 1210 is selected by the row address R_ADD and the column address C_ADD. During a read operation, user data may be sensed from the memory area corresponding to the row address R_ADD and the column address C_ADD of the cell array 1210.

The sub-address decoder 1254 decodes the address ADDR packet input through the command/address line CA to extract a sub-address S_ADD. Among the address ADDR input sequences inputted subsequent to the command CMD by the sub-address decoder 1254, the sub-address S_ADD can be extracted from one or more packets. Then, the sub-address decoder 1254 transmits the sub-address S_ADD extracted from the address packet to the sub-data register 1275. At least one of a plurality of sub-data existing in the sub-data register 1275 can be selected by the sub-address S_ADD.

The configuration of the address decoder for decoding the sub-address S_ADD has been explained through the above-described example embodiments referring to FIGS. 6 and 7. However, it will be well understood that the decoding method of the sub-address S_ADD is not limited to the above-described methods.

FIG. 8 is a timing diagram showing a method of exchanging data with a non-volatile memory device using the separate command/address SCA protocol of some example embodiments of the present invention. Referring to FIG. 8, the storage controller (1100, see FIG. 1) can select sub-data output from the non-volatile memory device (1200, see FIG. 3) using the sub-address S_ADD transmitted to the command/address line CA.

At time T0, the storage controller 1100 inputs a command CMD and an address (C_ADD, R_ADD, S_ADD) that instructs the input or output of data to the non-volatile memory device 1200 through the command/address line CA. First, at time T0, a command CMD, at time T1, a column address C_ADD, at time T2, a row address R_ADD, and at time T3, a sub-address S_ADD can be inputted to the non-volatile memory device 1200.

At time T5, input data corresponding to the command CMD and the address (C_ADD, R_ADD) can be inputted to the data line (DQ[7:0]). Or, output data specified by the command CMD and the address (C_ADD, R_ADD) can be outputted to the data line (DQ[7:0]). The input data or the output data can be inputted or outputted through the data line (DQ[7:0]) until time T7.

At the time of T5, the sub-data selected by the sub-address S_ADD can be inputted or outputted through the command/address line (CA[1:0]) at the same time as the input or output data of the data line (DQ[7:0]). When data is inputted, the sub-data can be provided as stream information or reliability data such as temperature for the input data by the storage controller (1100, see FIG. 1). When data is outputted, the sub-data can be any one of the soft decision data generated from the read data by the non-volatile memory device (1200, see FIG. 3), compressed soft decision data, bit count of the read data, temperature information, attribute data of the read data, or reliability data. Among various sub-data, the data selected by the sub-address S_ADD can be outputted.

In the above, the transmission of the sub-address S_ADD through the command/address line CA in the storage device 1000 of some example embodiments of the present invention and the input or output method of the sub-data selected by the sub-address S_ADD have been described. The sub-data that can be exchanged through the command/address line CA can be selected by the sub-address S_ADD. Therefore, the types of sub-data may rapidly increase in accordance with higher integration and/or higher performance of the non-volatile memory device 1200 in the future. In some example embodiments, a separate command/address protocol is provided that can select the types of sub-data, which may rapidly increase, through the sub-address S_ADD.

FIG. 9 is a timing diagram showing a read operation of a storage device using a separate command/address SCA protocol of some example embodiments. Referring to FIG. 9, a storage controller (1100, see FIG. 1) can receive read data from a non-volatile memory device (1200, see FIG. 1) through a data line DQ[7:0] and sub-data through a command/address line CA[1:0]. The storage controller 1100 can select sub-data output to the command/address line CA[1:0] using an added sub-address S_ADD.

At time T0, the storage controller 1100 transmits a read command set ‘00 h˜30 h’ that instructs the non-volatile memory device 1200 to read data through the command/address line CA. The address cycle of the read command set ‘00 h˜30 h’ includes a column address ‘C’, a row address ‘R’, and a sub-address ‘S’. Here, the command codes ‘00 h’, ‘30 h’ and address sets ‘C’, ‘R’, ‘S’ of the read command set ‘00 h˜30 h)’ may each be provided in the form of a packet, but example embodiments are not limited to the form of a packet. At time T1, a column address ‘C’, at time T2, a row address ‘R’, and at time T3, a sub-address ‘S’ may be inputted to the non-volatile memory device 1200. At time T5, when the input of the read command set ‘00 h˜30 h’ including the column address ‘C’, the row address ‘R’, and the sub-address ‘S’ is completed, the ready/busy signal R/B transitions to a low level. During the low level of the ready/busy signal R/B (T5 to T6), the non-volatile memory device 1200 may perform a data read operation of a selected area and a sub-data generation operation.

At time T7, the storage controller 1100 can transmit a random data out command set ‘05 h˜E0 h’ to the non-volatile memory device 1200 via the command/address line CA. While the data requested via the read command set ‘00 h˜30 h’ is prepared, one or two random data output sequences are generally preceded. The address cycle of the random data out command set ‘05 h˜E0 h’ can include a column address ‘C’ and a sub-address ‘S’ provided at time T8. After the input of the random data out command set ‘05 h˜E0 h’ (time T9), a select chip enable signal SCE can be provided.

At time T10, random data can be outputted via the data line DQ[7:0]. At the same time, sub-data corresponding to the random data is outputted. The sub-data output at this time can be selected by the sub-address ‘S’ of the read command set ‘00 h˜30 h’ and the random data out command set ‘05h˜E0 h’ that is inputted later. At the time point T11 when the output of the random data is completed, a selection chip termination signal SCT is provided through the command/address line CA.

In the above example embodiments, the transmission of the sub-address S_ADD through the command/address line CA during the read operation in the storage device 1000 of some example embodiments and the output method of the sub-data selected by the sub-address S_ADD have been described. Although the output of the sub-data in the output section of the random data has been described as an example, the read data may be outputted through the data line DQ and the sub-data may be outputted through the command/address line CA in the output section of the read data performed later.

FIG. 10 is a timing diagram showing the write operation of the storage device using the separate command/address SCA protocol of some example embodiments of the present invention. Referring to FIG. 10, the storage controller (1100, see FIG. 1) provides a write command set ‘80 h˜12 h’ and sub-data and write data to a non-volatile memory device (1200, see FIG. 1) using a command/address line CA. The storage controller 1100 can select at least one of a plurality of sub-data using a sub-address S_ADD included in the write command set ‘80 h˜10 h’.

At time T0, the storage controller 1100 transmits a write command set ‘80 h˜10 h’ that instructs the non-volatile memory device 1200 to write data through the command/address line CA. The address input cycle of the write command set ‘80 h˜10 h’ includes a column address ‘C’, a row address ‘R’, and a sub-address ‘S’. Here, the commands ‘80 h’, ‘12 h’, ‘10 h’ of the write command set ‘80 h˜10 h’, the address sets ‘C’, ‘R’, ‘S’, and the sub-data may each be provided in the form of packets, but example embodiments are not limited to the packet form. At time T1, a column address ‘C’, at time T2, a row address ‘R’, and at time T3, a sub-address ‘S’ may be inputted into the non-volatile memory device 1200. When the input of the column address ‘C’, the row address ‘R’, and the sub-address ‘S’ is completed at time T4 and a select chip enable signal SCE is provided, write data is inputted to the data line DQ. At the same time, sub-data including at least one of reliability, attribute, and stream information of the write data may be inputted to the command/address line CA. In the case of sub-data input during the write operation, stream information, importance(weight), or reliability information of the write data may be included. The storage controller 1100 may provide sub-data, which is an attribute value specified by a sub-address ‘S’ among various attributes, through a command/address line CA.

When the input of the write data is completed at time T7, the storage controller 1100 transmits a selection chip termination signal SCT to the non-volatile memory device 1200 through the command/address line CA. Then, when the second code ‘10 h’ of the write command set is inputted to the non-volatile memory device 1200 at time T8, the ready/busy signal R/B transitions to a low level.

In the above, the transmission of the sub-address S_ADD through the command/address line CA during the write operation in the storage device 1000 of some example embodiments of the present invention and the input method of the sub-data selected by the sub-address S_ADD have been described.

FIG. 11 is a timing diagram showing an example of a packet configuration applied to the separate command/address SCA protocol of some example embodiments of the present invention. Referring to FIG. 11, the storage controller 1100 can transmit a command, data, and address to the non-volatile memory device 1200 in the form of a packet through the command/address line CA. Here, an example in which the packet transmitted through the command/address line CA consists of a 4-bit header and an 8-bit body will be described.

At time T0, the storage controller 1100 activates a chip enable signal CA_CE# to select a chip of the non-volatile memory device 1200 to which the separate command/address SCA protocol is applied to a low level. In response to the activation of the chip enable signal CA_CE#, the non-volatile memory device 1200 prepares for data exchange through the command/address line CA.

At time T1, the storage controller 1100 sequentially transmits a packet header to the command/address line CA along with the transition of the CA clock signal CA_CLK. At time T1, the head bits (h[0], h[1]) of the command/address line CA may be transmitted to the input/output circuit 1240 of the non-volatile memory device 1200 in synchronization with the rising edge of the CA clock signal CA_CLK. And at time T2, the head bits (h[2], h[3]) of the command/address line CA are transmitted to the input/output circuit 1240 of the non-volatile memory device 1200 in synchronization with the falling edge of the CA clock signal CA_CLK.

At time T3, the storage controller 1100 sequentially transmits the packet body to the command/address line CA along with the transition of the CA clock signal CA_CLK. At time T3, the body bits (b[0], b[1]) of the command/address line CA may be transmitted to the input/output circuit 1240 of the non-volatile memory device 1200 in synchronization with the rising edge of the CA clock signal CA_CLK. And at the time point T4, the body bits (b[2], b[3]) of the command/address line CA are transmitted to the input/output circuit 1240 of the non-volatile memory device 1200 in synchronization with the falling edge of the CA clock signal CA_CLK. At the time point T5, the body bits (b[4], b[5]) of the command/address line CA are transmitted to the input/output circuit 1240 of the non-volatile memory device 1200 in synchronization with the rising edge of the CA clock signal CA_CLK. And at the time point T6, the body bits (b[6], b[7]) of the command/address line CA are transmitted to the input/output circuit 1240 of the non-volatile memory device 1200 in synchronization with the falling edge of the CA clock signal CA_CLK. When the transmission of the packet is completed, the storage controller 1100 can deactivate the chip enable signal CA_CE# at the time point T7.

Various commands, addresses, and types of data to be transmitted can be defined through the bit values of the 4-bit header (h[0], h[1], h[2], h[3]) of the packet transmitted through the command/address line CA. For example, the read command or the sub-address S_ADD can also be provided in the form of a packet transmitted through the command/address line CA described above. It will be well understood that the number of bits of the header or body of the packet can be changed variously depending on the example embodiments.

FIG. 12 is a table showing the definition of packet data according to the bit value of the packet header of FIG. 11. Referring to FIG. 12, data output, data input, command, address, etc. to the command/address line CA can be defined according to the bit value of the packet header.

The packet header bits (CA[1], CA[0]) are transmitted to the non-volatile memory device 1200 in synchronization with the rising edge of the CA clock signal CA_CLK. And the packet header bits (CA[1], CA[0]) are transmitted to the non-volatile memory device 1200 in synchronization with the falling edge of the CA clock signal CA_CLK. If the bit value of the 4-bit packet header bits transmitted in synchronization with the rising and falling edges of the CA clock signal CA_CLK is ‘0000’, it can correspond to data output through the command/address line CA. That is, the packet header bit value ‘0000’ instructs the non-volatile memory device 1200 to output data to the storage controller 1100. The non-volatile memory device 1200 can use the packet header bit value ‘0000’ to notify the storage controller 1100 of the output of data when outputting specific data. Sub-data may be provided in the packet body following the packet header bit value ‘0000’. That is, the packet body following the packet header bit value ‘0000’ may include at least one of the sub-data of soft decision data, compressed soft decision data, bit count, temperature data, and reliability data.

When the bit value of the 4-bit packet header bits is ‘0010’, it can respond to data input through the command/address line CA. That is, the packet header bit value ‘0010’ corresponds to a packet header for inputting data from the storage controller 1100 to the non-volatile memory device 1200. The storage controller 1100 can use the packet header bit value ‘0010’ to notify the non-volatile memory device 1200 of the input of specific data through the command/address line CA. The packet body following the packet header bit value ‘0010’ may include write sub-data such as stream information or importance(weight) of write data. In addition, compression setting data such as a setting value for compressing the soft decision data or a mapping table for compression may be transmitted from the non-volatile memory device 1200.

In addition, when the bit value of the 4-bit packet header bits is ‘1000’, it indicates a command provided from the storage controller 1100 to the non-volatile memory device 1200 through the command/address line CA. The definition of the type of the command may be transmitted through the packet body.

If the bit value of the 4-bit packet header bits is ‘1100’, the address transmitted from the storage controller 1100 to the non-volatile memory device 1200 through the command/address line CA may be indicated. For example, the row address R_ADD or the column address C_ADD may be inputted using the bit value of the packet header bits as ‘1100’.

If the bit value of the 4-bit packet header bits is ‘1110’, it indicates the sub-address S_ADD provided from the storage controller 1100 to the non-volatile memory device 1200 through the command/address line CA. The sub-address ‘S’ input in FIG. 9 or FIG. 10 may be inputted to the non-volatile memory device 1200 using the packet header bit ‘1110’ if provided in the form of a packet. At this time, the body of the sub-address S_ADD packet may be provided with selection bits that designate one of the plurality of sub-data to be selected.

When the bit value of the 4-bit packet header bits is ‘1101’, it corresponds to the selection chip enable signal SCE, and when the bit value of the packet header bits is ‘1111’, it corresponds to the selection chip termination signal SCT.

FIG. 13 is a timing diagram showing a command and address transmission method using the separate command/address SCA protocol of some example embodiments of the present invention. Referring to FIG. 13, the storage controller (1100, see FIG. 1) can transmit command packets and address packets to the non-volatile memory device 1200 using the command/address line (CA[1:0]).

At time T0, the storage controller 1100 transmits a command packet to the non-volatile memory device 1200. The command packet consists of a header and a body. The header of the command packet is expressed as ‘1000’ when expressed as the consecutive bits of (CA[1], CA[0]) at the rising edge of the CA clock signal CA_CLK and (CA[1], CA[0]) at the falling edge. This means that it is the packet for transmitting the command as defined in the table of FIG. 12. Next, at time T1, the body of the command packet is transmitted. For example, an 8-bit packet body ‘01001001’ may be transmitted. The type of the command may be determined through the packet body. For example, a read command, a write command, an erase command, etc. may be provided through the packet body. In the section where the command set is transmitted in the storage controller 1100, the ready/busy signal R/B may be set to a high level H.

Transmission of address packets begins from time T2. First, column address packets CA0 and CA1 are input to the non-volatile memory device 1200 in synchronization with the rising edge and falling edge of the CA clock signal CA_CLK from time T2 to time T4. The packet header bit value of the column address packet ‘CA0 Packet’ is ‘1100’, indicating the address packet. And the packet body bit value ‘00111000’ of the column address packet ‘CA0 Packet’ indicates the column address CA0. The column address packet ‘CA1 Packet’ is also input with the packet header bit value ‘1100’. And the packet body bit value ‘10010010’ of the column address packet ‘CA1 Packet’ indicates the column address CA1.

Transmission of row address packets RA0, RA1 and RA2 starts from time T4. The packet header bit value of the row address packet ‘RA0 Packet’ is provided as ‘1100’, which indicates that it is an address packet, similar to the column address packets. In addition, each of the row address packets RA0, RA1 and RA2 is followed by a packet body. The row address of the cell array 1210 can be determined through the packet body of each of the row address packets RA0, RA1 and RA2.

At time T6, the storage controller 1100 transmits the sub-address packet ‘SA Packet’ to the non-volatile memory device 1200. The sub-address packet consists of a header and a body. The header of the sub-address packet is expressed as ‘1110’ when expressed as the consecutive bits of (CA[1], CA[0]) at the rising edge of the CA clock signal CA_CLK and (CA[1], CA[0]) at the falling edge. This means that the packet is intended to transmit the sub-address, as defined in the table of FIG. 12. Next, at the T7 point in time, the body of the sub-address packet is transmitted. For example, an 8-bit packet body ‘01100001’ is illustrated. At least one of a plurality of sub-data stored in a sub-data register (1275, see FIG. 3) is selected through the packet body. For example, at least one of soft decision data, compressed soft decision data, ‘0’ bit count, ‘1’ bit count, temperature information, and reliability information stored in the sub-data register 1275 may be selected. In the write operation mode, attributes of sub-data indicating stream information, temperature, importance, etc. may be provided through the body bits of the sub-address packet.

FIG. 14 is a table showing sub-data selected by the body bit of the sub-address packet illustrated in FIG. 13. Referring to FIG. 14, at least one of various sub-data stored in the sub-data register (1275, see FIG. 3) can be selected through the body bit of the sub-address packet.

For example, if the body bit of the sub-address packet is ‘0000000’, soft-decision data for the read data output to the data line DQ can be selected. If the body bit of the sub-address packet is ‘0000001’, compressed soft-decision data can be selected. If the body bit of the sub-address packet is ‘0000010’, the number of bits of logic ‘0’ included in the read data output to the data line DQ can be selected. If the body bit of the sub-address packet is ‘0000011’, the number of bits of logic ‘1’ included in the read data output to the data line DQ can be selected. If the body bit of the sub-address packet is ‘00000100’, the temperature information detected during the sensing operation of the read data output to the data line DQ can be selected. If the body bit of the sub-address packet is ‘00000101’, the reliability information of the read data can be selected as the sub-data. If the body bit of the sub-address packet is ‘00000110’, the sub-data input to the command/address line CA can indicate that it corresponds to the stream information of the write data.

As described above, at least one of the plurality of sub-data stored in the sub-data register (1275, see FIG. 3) can be selected through the packet body bit of the sub-address. During the write operation, sub-data attributes indicating the stream information, temperature, importance, etc. of the write data can be provided through the body bit of the sub-address packet. The types of sub-data that can be selected through the packet body bits of the sub-address can be added in various ways as desired, and example embodiments are not limited to the illustrated sub-data.

FIG. 15 is a diagram showing a process of outputting sub-data in a storage device using a separate command/address SCA protocol. Referring to FIG. 15, the storage controller 1100 can select at least one of the sub-data using the sub-address by using the command/address line CA. The non-volatile memory device 1200 can provide the sub-data selected by the sub-address to the storage controller 1100.

In step S10, the storage controller 1100 can provide a read command to the non-volatile memory device 1200 according to the separate command/address SCA protocol. At this time, the target area is selected through the command packet and the address packet transmitted to the command/address line CA. The address packet includes a row address and a column address for selecting a target area of the cell array 1210. In addition, the address packet also includes a sub-address for selecting sub-data for the data requested to be read.

In step S20, the non-volatile memory device 1200 selects a memory area corresponding to the provided row address and column address. Then, the non-volatile memory device 1200 senses read data from the selected area.

In step S30, the non-volatile memory device 1200 generates sub-data for the sensed read data. For example, the non-volatile memory device 1200 may sense the soft decision data using the page buffer circuit 1230. Alternatively, the non-volatile memory device 1200 may perform a compression operation on the sensed soft decision data to generate compressed soft decision data. Alternatively, the non-volatile memory device 1200 may generate sub-data by counting the number of bits of logic ‘0’ or ‘1’ from the read data stored in the page buffer circuit 1230. Alternatively, the operation temperature information of the non-volatile memory device 1200 at the sensing point may be generated as sub-data. The generated sub-data may be stored in the sub-data register (1275, see FIG. 3).

In step S40, the non-volatile memory device 1200 selects at least one of the plurality of sub-data stored in the sub-data register 1275. For example, the non-volatile memory device 1200 may select sub-data specified by the sub-address.

In step S50, the non-volatile memory device 1200 outputs the read data to the storage controller 1100 through the data line DQ. At the same time, in step S55, the non-volatile memory device 1200 may transmit the selected sub-data to the storage controller 1100 via the command/address line CA.

In the above, data transmission procedure between the storage controller 1100 and the non-volatile memory device 1200 according to the separate command/address SCA protocol have been described. The storage device 1000 can select the sub-data transmitted to the command/address line CA via the sub-address.

FIG. 16 is a flowchart showing an operation method according to the separate command/address SCA protocol of the storage controller of some example embodiments of the present invention. Referring to FIG. 16, the storage controller 1100 can request sub-data from a non-volatile memory device (1200, see FIG. 1) through a command/address line CA according to the separate command/address SCA protocol. At this time, a sub-address S_ADD that can select at least one of various sub-data can be transmitted to the non-volatile memory device 1200 in an address input cycle.

In step S110, the storage controller 1100 generates a read command to read a selected area of the non-volatile memory device 1200. The read command includes a command set, a column address C_ADD, a row address R_ADD, and a sub-address S_ADD. The storage controller 1100 may generate a sub-address S_ADD for selecting a type of sub-data related to read data.

In step S120, the storage controller 1100 transmits the generated command set and address C_ADD, R_ADD and S_ADD to the non-volatile memory device 1200 through the command/address line CA. The command set and address C_ADD, R_ADD and S_ADD may be transmitted in the form of a packet that is inputted in synchronization with the CA clock signal CA_CLK.

In step S130, the storage controller 1100 may transmit a random data request while the read-requested data is loaded into the page buffer circuit 1230 of the non-volatile memory device 1200. The command set for the random data request may also include the sub-address S_ADD.

In step S140, the storage controller 1100 can receive read data and sub-data output from the non-volatile memory device 1200. If random data is outputted before the read data, the random data may be outputted through the data line DQ, and sub-data corresponding to the random data may be outputted through the command/address line CA. After the output of the random data is completed, the read data may be outputted through the data line DQ, and sub-data of the read data may be outputted through the command/address line CA.

FIG. 17 is a flowchart showing an operation method according to the separate command/address SCA protocol of the non-volatile memory device of some example embodiments of the present invention. Referring to FIG. 17, the non-volatile memory device 1200 receives a command set including a sub-address through the command/address line CA according to the separate command/address SCA protocol. And the non-volatile memory device 1200 can transmit the read-requested data and sub-data to the storage controller 1100 according to the separate command/address SCA protocol.

In step S210, the non-volatile memory device 1200 receives a read command set including a sub-address through a command/address line CA.

In step S220, the non-volatile memory device 1200 senses read data from a selected memory area in response to the read command.

In step S230, the sub-data generator (1270, see FIG. 3) of the non-volatile memory device 1200 generates sub-data for the read data. For example, the sub-data generator 1270 can generate soft decision data for the read data, compressed soft decision data, bit count of the read data, temperature information, reliability information, etc. The generated sub-data are stored in the sub-data register 1275.

In step S240, the non-volatile memory device 1200 selects at least one of the plurality of sub-data stored in the sub-data register 1275 requested through the sub-address.

In step S250, the non-volatile memory device 1200 outputs read data through the data line DQ. Then, the non-volatile memory device 1200 transmits the selected sub-data to the storage controller 1100 through the command/address line CA.

The read operation using the separate command/address SCA protocol of some example embodiments the present invention has been described through the above-described FIGS. 16 and 17. The non-volatile memory device 1200 of the example embodiments can receive the sub-address through the command/address line CA. The non-volatile memory device 1200 can transmit the selected sub-data together with the read data through the sub-address.

One or more of the elements disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The above are some example embodiments for carrying out the present invention. In addition to the above-described example embodiments, the example embodiments may include simple design changes or easily changeable example embodiments. In addition, some example embodiments of the present invention may include techniques that can be easily modified and implemented using the example embodiments. Therefore, the scope of the present invention should not be limited to the above-described example embodiments, and should be defined by the claims and equivalents of the claims of the present invention as well as the claims to be described later.

What is claimed is:

1. A storage device comprising:
a storage controller configured to transmit a command and an address via a command/address line, the command/address line separate from a data line; and
a non-volatile memory device configured to exchange a first data with the storage controller via the data line and exchange a second data in synchronization with the first data via the command/address line,
wherein the storage controller transmits a sub-address associated with selecting at least one of a plurality of sub-data in synchronization with the first data to the non-volatile memory device using the command/address lines.

2. The storage device of claim 1, wherein
the least one of the plurality of sub-data include at least one of
a soft decision data associated with the first data,
a compressed data of the soft decision data,
a bit count of a logic value included in the first data,
a temperature information,
an attribute data of the first data, and
a reliability data.

3. The storage device of claim 1, wherein
the least one of the plurality of sub-data include at least one of
a stream information,
an importance information, and
a reliability information of the first data.

4. The storage device of claim 1, wherein
the sub-address is included in a plurality of sub-addresses, and
the second data is determined according to a last sub-address inputted among the plurality of sub-addresses inputted before the second data is outputted.

5. The storage device of claim 1, wherein the sub-address is inputted to the non-volatile memory device following a column address and a row address.

6. The storage device of claim 1, wherein the command, the address, and the sub-address are transmitted to the non-volatile memory device in a packet including a header part and a body part.

7. The storage device of claim 6, wherein a bit value of the header part is defined according to a transmission direction of the packet transmitted to the command/address line.

8. The storage device of claim 7, wherein the body part of the packet corresponding to the sub-address includes selection information of the second data.

9. A non-volatile memory device, comprising:
a cell array including a memory area is configured to be selected by a first address;
a page buffer configured to sense a read data from the selected memory area;
a sub-data register configured to store a plurality of sub-data corresponding to the read data;
a control circuit configured to provide a second address associated with selecting at least one of the plurality of sub-data to the sub-data register; and
an input/output circuit configured to
receive the first address and the second address through a command/address line, the command/address line separate from a data line,
provide the first address and the second address to the control circuit, and
output a selected sub-data of the plurality of sub-data to the command/address line in synchronization with the output of the read data.

10. The non-volatile memory device of claim 9, wherein
the plurality of sub-data includes at least one of
a soft decision data associated with read data,
a compressed data of the soft decision data,
a bit count of a logic value included in the read data,
a temperature information,
an attribute data, and
a reliability data of the read data.

11. The non-volatile memory device of claim 9, wherein
the second address is included in a read command set provided through the command/address line, and
the second address is transmitted to the input/output circuit subsequent to the first address.

12. The non-volatile memory device of claim 9, further comprising:
a sub-data generator configured to generate the plurality of sub-data from the read data sensed by the page buffer.

13. The non-volatile memory device of claim 9, wherein
a command, the first address, and the second address transmitted to the input/output circuit through the command/address line are provided in a packet,
the packet including a header part and a body part.

14. The non-volatile memory device of claim 13, wherein the second address is set to a packet header part different from the first address.

15. The non-volatile memory device of claim 9, wherein the input/output circuit receives a command/address clock signal associated with receiving a command, the first address, and the second address transmitted through the command/address line.

16. A method of operating a non-volatile memory device, comprising:
receiving a command, a first address, and a second address through a command/address line, the command/address line separate from a data line;
sensing a read data corresponding to the first address;
selecting at least one of a plurality of sub-data according to the second address;
outputting the read data through the data line; and
outputting the at least one of a plurality of sub-data selected in synchronization with the output of the read data through the command/address line.

17. The method of claim 16, further comprising:
generating the plurality of sub-data from the read data to store the plurality of sub-data in a sub-data register.

18. The method of claim 17, wherein
the plurality of sub-data include at least one of
a soft decision data associated with the read data,
a compressed data of the soft decision data,
a bit count of a logic value included in the read data,
a temperature information,
an attribute data, and
a reliability data of the read data.

19. The method of claim 16, further comprising:
receiving a command/address clock signal associated with receiving at least one of the command, the first address and the second address transmitted through the command/address line.

20. The method of claim 16 wherein the command, the first address, and the second address are inputted through the command/address line in the form of a packet including a header part and a body part.
